(19) United States
(12) Patent Application Publication
(10) Pub. No.: US 2016/0323173 A1
(43) Pub. Date: Nov. 3, 2016

(54) OUTCOMES-BASED APPLICATION MONITORING

(71) Applicant: INTERNATIONAL BUSINESS MACHINES CORPORATION, Armonk, NY (US)

(72) Inventors: John A. Bivens, Westchester, NY (US); Minkyong Kim, Westchester, NY (US); Min Li, Blacksburg, VA (US); Clifford A. Pickover, Westchester, NY (US); Valentina Salapura, Westchester, NY (US)

(21) Appl. No.: 14/744,701

(22) Filed: Jun. 19, 2015

Related U.S. Application Data
(63) Continuation of application No. 14/700,818, filed on Apr. 30, 2015.

(51) Int. Cl. H04L 12/26; G06Q 50/18; G06Q 50/00

(52) U.S. Cl. CPC H04L 43/14; G06Q 50/01; G06Q 50/184

(57) ABSTRACT

A system and method are provided. The method includes receiving, by a server, characteristics of a work product produced by using at least one application in a device. The method further includes computing, by the server, measures of at least one of a complexity, a quality, and an expertise level for the work product responsive to the characteristics. The method also includes determining, by the server, whether to cause at least one hardware device to selectively perform an action relating to using the application, responsive to the measures.

### CROSS-REFERENCE TO RELATED APPLICATIONS

This application is a Continuation application of co-pending U.S. patent application Ser. No. 14/700,818 filed on Apr. 30, 2015 incorporated herein by reference in its entirety.

### BACKGROUND

1. Technical Field

The present invention relates generally to information processing and, in particular, to outcomes-based application monitoring.

2. Description of the Related Art

Software usage metering has been exploited for various purposes. For example, one software usage metering application provides comprehensive and detailed software usage statistics so one can avoid purchasing and supporting applications that are not being utilized. By identifying unused software, one can reallocate copies to users who truly need them, or renegotiate software contracts so they reflect actual usage, saving your organization significant amounts of money.

### SUMMARY

According to an aspect of the present principles, a method is provided. The method includes receiving, by a server, characteristics of a work product produced by using at least one application in a device. The method further includes computing, by the server, measures of at least one of a complexity, a quality, and an expertise level for the work product responsive to the characteristics. The method also includes determining, by the server, whether to cause at least one hardware device to selectively perform an action relating to using the application, responsive to the measures.

According to another aspect of the present principles, a system is provided. The system includes a server for receiving characteristics of a work product produced by using at least one application in a device, computing measures of at least one of a complexity, a quality, and an expertise level for the work product responsive to the characteristics, and determining whether to cause at least one hardware device to selectively perform an action relating to using the application, responsive to the measures.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 shows an exemplary processing system 100 to which the present principles may be applied, in accordance with an embodiment of the present principles;

FIG. 2 shows an exemplary system 200 for outcome-based application monitoring, in accordance with an embodiment of the present principles;

FIG. 3 shows an exemplary system 300 with a proxy for outcome-based application monitoring, in accordance with an embodiment of the present principles;

FIG. 4 shows an exemplary outcome server 400 for outcomes-based application monitoring, in accordance with an embodiment of the present principles;

FIG. 5 shows an exemplary outcome proxy server 500 for outcomes-based application monitoring, in accordance with an embodiment of the present principles;

FIG. 6 shows an exemplary method 600 for outcomes-based application monitoring, in accordance with an embodiment of the present principles;

FIG. 7 shows an exemplary cloud computing node 710, in accordance with an embodiment of the present principles;

FIG. 8 shows an exemplary cloud computing environment 850, in accordance with an embodiment of the present principles; and

FIG. 9 shows exemplary abstraction model layers, in accordance with an embodiment of the present principles.

### DETAILED DESCRIPTION OF PREFERRED EMBODIMENTS

The present principles are directed to outcomes-based application monitoring.

In an embodiment, the present principles involve receiving characteristics of a work product produced by using at least one application in a device, computing measures of at least one of a complexity, a quality, and an expertise level for the work product responsive to the characteristics, and determining whether to cause at least one hardware device to selectively perform an action relating to using the application, responsive to the measures.

The work product can be, for example, but is not limited to, a multimedia presentation/file, music, a report, a software tool or an object (e.g., an image, a document, a book, etc.) created using the application, a publishing, and so forth. The characteristics can be any characteristics of the work product, as readily contemplated by one of ordinary skill in the art. For example, characteristics of a work product can include, but are not limited to, whether it was published, how many times it has been accessed, how many times it has been downloaded, how many times it has been purchased, how many errors were generated during creation of the work product, how many colors the work product involves, the skill level in generating the work product, the skill level in using at least one application that created the work product, and so forth. The characteristics of the work product can be embodied and/or otherwise conveyed in a “work product characteristics signal”. This signal can be, for example, output from an application relating to the work product or monitored from an application relating to the work product.

From these characteristics, one or more of the measures are determined. The measures, as noted above, can be of, for example, a complexity, a quality, and an expertise level for a work product produced by using an application. The measures can be considered to relate to and/or otherwise represent an “application use outcome”, that is an outcome of using an application that is based on the work product of the application. In an embodiment, these measures can be indicative of a degree of success achieved by and/or through the work product. Based on the measures, an action relating to the application can be performed such as offering an updated license, offering a complimentary or more advanced product, and so forth. Offerings/suggestions can be based on, for example, the usage of applications by other users in a social network

Exemplary “application use outcomes (“outcomes” in short) can include, but are not limited to, any of the following: publishing a work product of the application (including, but not limited to, e.g., document, image, sound file, and so forth), where publishing a work product of the application includes publishing to a website such as a media disseminating/access website including, but not limited to YouTube®, and so forth); emailing a work product of the application; printing a work product of the application; involving peripherals to convey or generate a work product; detecting a sharing with another user or multiple users (e.g., two or more users working on a document, and so forth); detecting a sharing of a work product between different devices (including, but not limited to, e.g., a PC, a laptop, a smart phone, a personal digital assistant, a tablet, a cloud storage device, a smart watch, and so forth); and a comparative outcome evaluation from any of the above (including, but not limited to, e.g., differentiating between publishing venues, or the title of the email recipient, and so forth).

The applications to which the present principles are applied can be running on, for example, but not limited to, a personal computer (PC), a laptop, a personal digital assistant, a media player, the cloud, a smartphone, a tablet, a smart watch, and so forth.

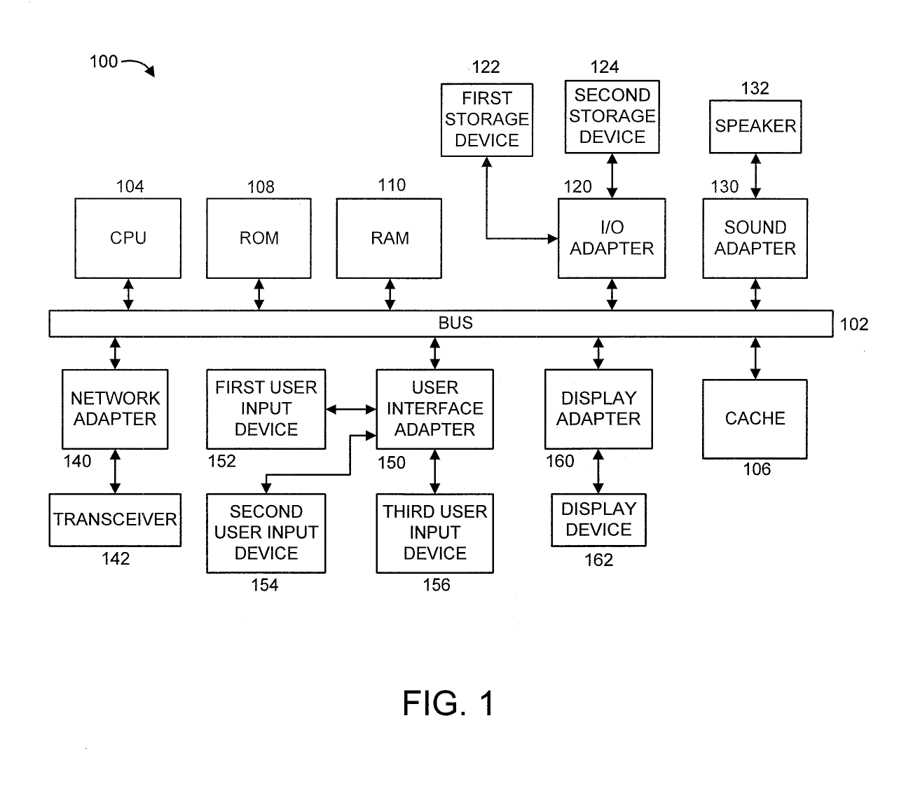

FIG. 1 shows an exemplary processing system 100 to which the present principles may be applied, in accordance with an embodiment of the present principles. The processing system 100 includes at least one processor (CPU) 104 operatively coupled to other components via a system bus 102. A cache 106, a Read Only Memory (ROM) 108, a Random Access Memory (RAM) 110, an input/output (I/O) adapter 120, a sound adapter 130, a network adapter 140, a user interface adapter 150, and a display adapter 160, are operatively coupled to the system bus 102.

A first storage device 122 and a second storage device 124 are operatively coupled to system bus 102 by the I/O adapter 120. The storage devices 122 and 124 can be any of a disk storage device (e.g., a magnetic or optical disk storage device), a solid state magnetic device, and so forth. The storage devices 122 and 124 can be the same type of storage device or different types of storage devices.

A speaker 132 is operatively coupled to system bus 102 by the sound adapter 130. A transceiver 142 is operatively coupled to system bus 102 by network adapter 140. A display device 162 is operatively coupled to system bus 102 by display adapter 160.

A first user input device 152, a second user input device 154, and a third user input device 156 are operatively coupled to system bus 102 by user interface adapter 150. The user input devices 152, 154, and 156 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present principles. The user input devices 152, 154, and 156 can be the same type of user input device or different types of user input devices. The user input devices 152, 154, and 156 are used to input and output information to and from system 100.

Of course, the processing system 100 may also include other elements (not shown), as readily contemplated by one of skill in the art, as well as omit certain elements. For example, various other input devices and/or output devices can be included in processing system 100, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system 100 are readily contemplated by one of ordinary skill in the art given the teachings of the present principles provided herein.

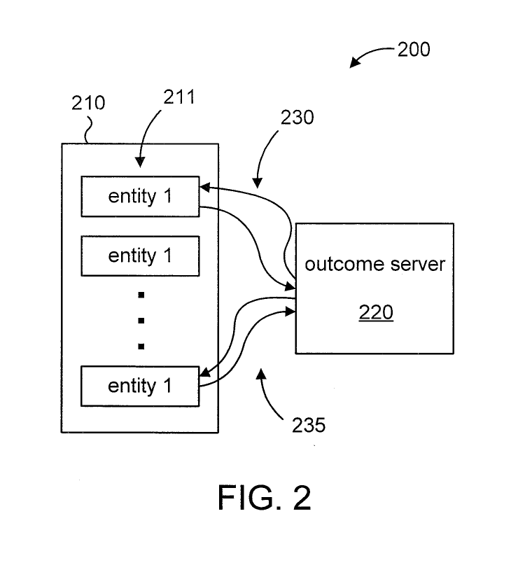

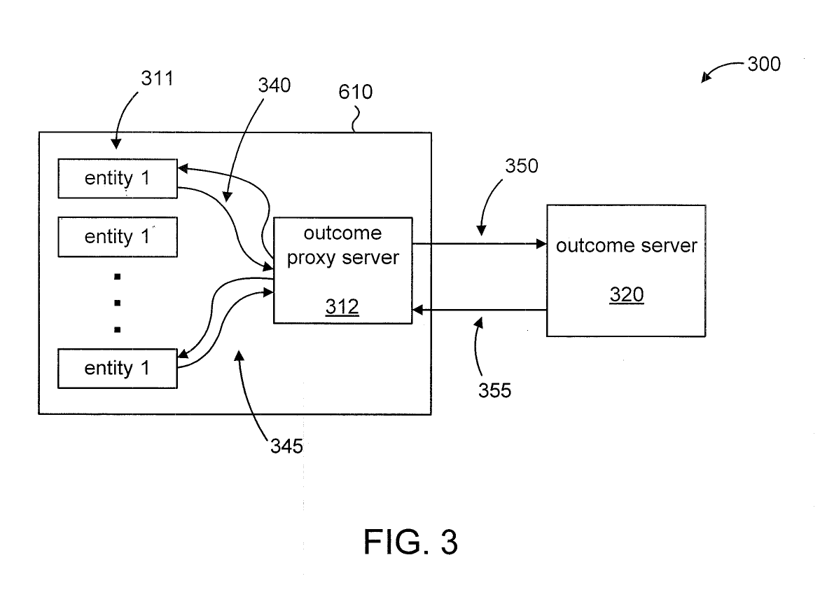

Moreover, it is to be appreciated that systems 200-300 described below with respect to FIGS. 2-3 are systems for implementing respective embodiments of the present principles. Part or all of processing system 100 may be implemented in one or more of the elements of systems 200-300.

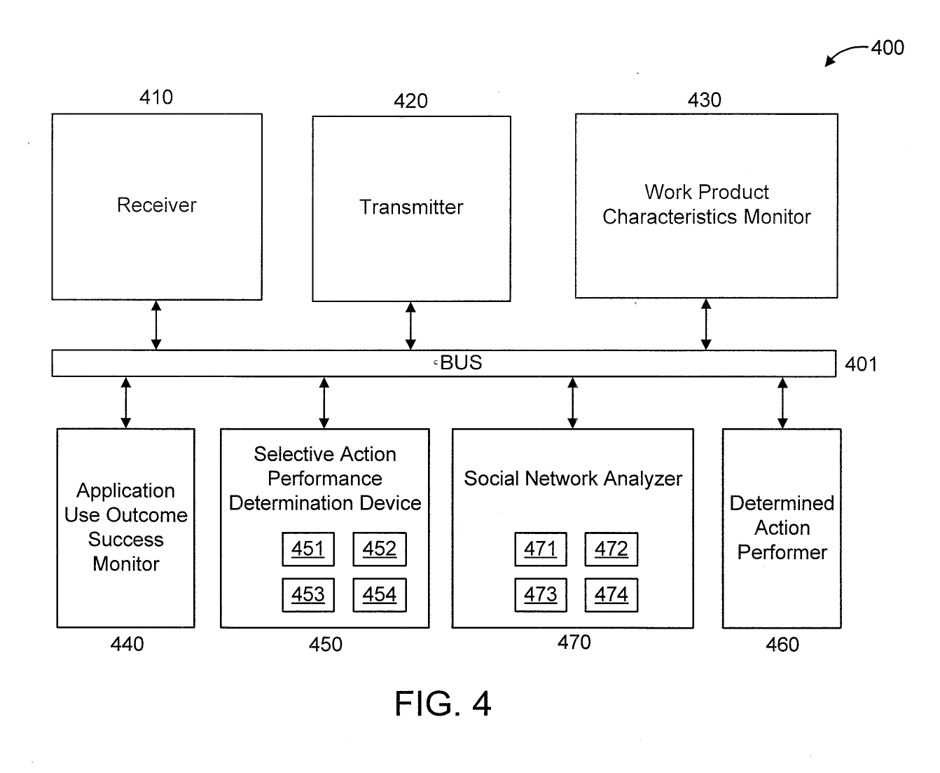

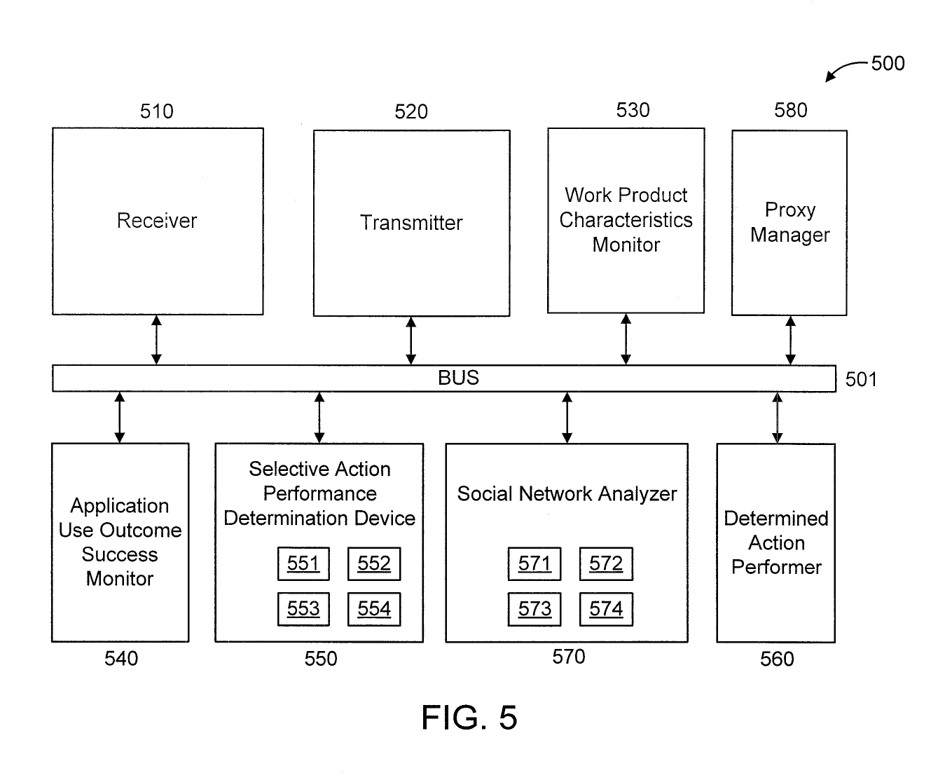

Also, it is to be appreciated that outcome server 400 and outcome proxy server 500 described below with respect to FIGS. 4 and 5 are servers for implementing respective embodiments of the present principles. Part or all of processing system 100 may be implemented in one or more of the elements of server 400 and server 500.

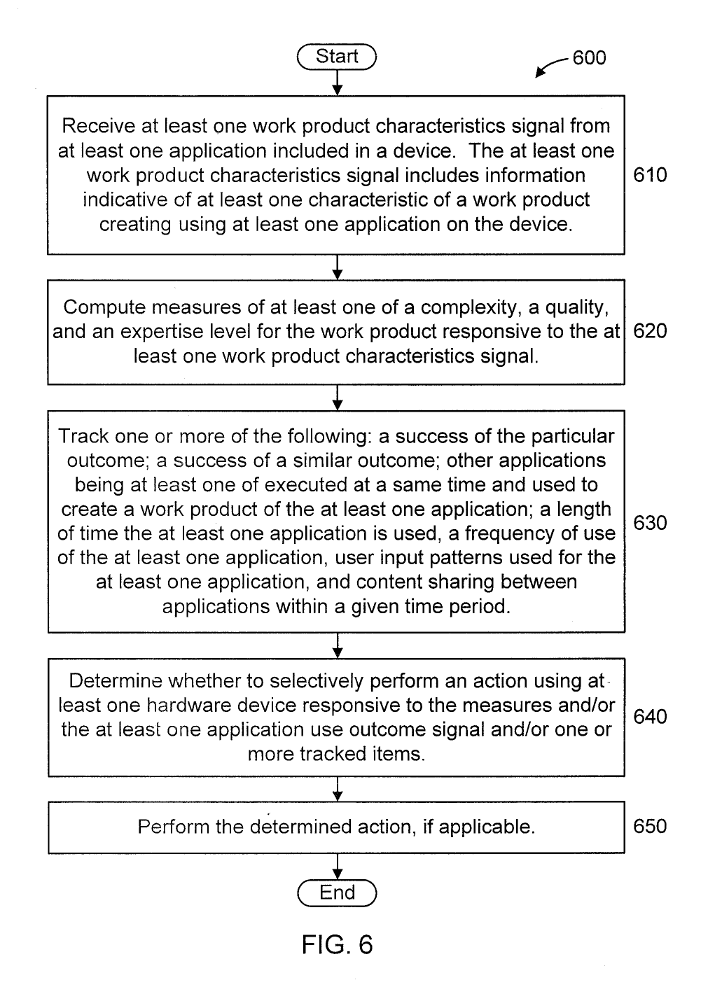

Further, it is to be appreciated that processing system 100 may perform at least part of the method described herein including, for example, at least part of method 600 of FIG. 6. Similarly, part or all of systems 200-300 and servers 400 and 500 may be used to perform at least part of method 600 of FIG. 6.

FIGS. 2-3 show various systems to which the present principles can be applied, in accordance with various embodiments of the present principles. In FIGS. 2-3, a device is shown. The device can be, but is not limited to, any of a personal computer (PC), a laptop, a personal digital assistant, a media player, the cloud, a smartphone, a tablet, a smart watch, and so forth. These figures are described with respect to work product characteristics signals, which are signals that include information indicative of one or more characteristics of a given work product. A “collective work product characteristics signal” is a conglomeration or grouping of more than one work product characteristic signal, that is, a set of multiple work product characteristics signals resulting from using one or more applications.

FIG. 2 shows an exemplary system 200 for outcome-based application monitoring, in accordance with an embodiment of the present principles. The system 200 involves a device 210 and an outcome server 220. The device 210 includes applications 1 through n, collectively denoted by the reference numeral 211. The applications 211 can provide respective work product characteristics signals, collectively denoted by the reference numeral 230, to the outcome server 220. The outcome server 220 can perform monitoring 235 (e.g., of information indicative of one or more characteristics of a work product creating by using at least one of the applications 211)) on the applications 211. In an embodiment, the applications 211 can provide the respective work product characteristics signals 230 using a push method. In an embodiment, the outcome server 220 can perform monitoring on the applications using a pull method. These and other techniques for obtaining information pertinent to the present principles are readily determined by one of ordinary skill in the art given the teachings of the present principles provided herein, while maintaining the spirit of the present principles.

FIG. 3 shows an exemplary pull-based system 300 with proxy for outcome-based application monitoring, in accordance with an embodiment of the present principles. The system 300 involves a device 310 and an outcome server 320. The device 310 includes applications 1 through n, collectively denoted by the reference numeral 311. The device 310 further includes an outcome proxy server 312. The applications 311 can provide respective work product characteristics signals, collectively denoted by the reference numeral 340, to the outcome proxy server 312. The outcome proxy server 312 can perform monitoring 345 (e.g., of information indicative of one or more characteristics of a work product creating by using at least one of the applications 211) on the applications 311. The outcome proxy server 312 can relieve the outcome server 320 of some functions relating to monitoring data. For example, the outcome proxy server 312 can perform the monitoring so that the outcome proxy server 320 simply receives the results from the monitoring. As such, the outcome server 320 can decide what to do in response to the monitoring without having to actually perform the monitoring itself. The outcome proxy server 312 can provide a collective work product characteristics signal 350 to the outcome server 320. The outcome server 320 can perform monitoring 355 (e.g., of, but not limited to, application use outcomes) on the applications 311 through the outcome proxy server 312. In an embodiment, the applications 311 can provide the respective work product characteristics signals 340 using a push method. In an embodiment, the outcome proxy server can provide the collective work product characteristics signal 350 to the outcome server 320 using a push method. In an embodiment, the outcome server 220 can perform monitoring on the applications 311 using a pull method. In an embodiment, the outcome server 320 can perform monitoring on the applications 311 through the outcome proxy server 312 using a pull method. These and other techniques for obtaining information pertinent to the present principles are readily determined by one of ordinary skill in the art given the teachings of the present principles provided herein, while maintaining the spirit of the present principles.

FIGS. 4 and 5 show exemplary implementations of the outcome server and the outcome proxy server mentioned in FIGS. 2-3. It is to be appreciated that while there is some overlap of description, the actual implementations of these servers is dependent upon the environment in which they will be used. For example, the functionality of these servers and their corresponding included hardware and so forth can vary depending upon if they are used in one configuration versus another from among those shown in FIGS. 2-3. Such variation is readily contemplated by one of ordinary skill given the teachings of the present principles provided herein, while maintaining the spirit of the present principles.

FIG. 4 shows an exemplary outcome server 400 for outcomes-based application monitoring, in accordance with an embodiment of the present principles.

The outcome server 400 includes a receiver 410, a transmitter 420, a work product characteristics monitor 430, an application use outcome success monitor 440, a selective action performance determination device 450; a determined action performer 460; and a social network analyzer 470.

In an embodiment, the receiver 410 receives work product characteristics signals. The work product characteristics signals can be received, for example, from applications in a device.

In an embodiment, the transmitter 420 transmits any of the following: an instruction to perform a particular action or set of actions; a suggestion (e.g., of an alternate application, a complimentary application, an optimized application, changed application characteristics, and so forth, e.g., based on application usage by users in a social network, etc.); a report (e.g., regarding application usage, available application licenses, and so forth); and an offer (e.g., of a valid application license, a rental mechanism (for at least one of an application, an alternate application, a complimentary application, and so forth), an upgraded license corresponding to a higher expertise level, and so forth). The preceding can be transmitted, e.g., to a device (e.g., such as any of devices 210 and).

The work product characteristics monitor 430 monitors characteristics of work products created using one or more applications.

The application outcome success monitor 440 monitors successful application use outcomes. As used herein, “success” refers to some measure of accomplishment for a particular outcome as compared to failing or being mediocre. Success (and, hence, a successful application use outcome) can be measured, for example, using one or more thresholds applied to one or more characteristics of a work product. For example, in the case of an outcome involving publishing a work product, success can be measured by the number of people who access the published work product with respect to a given threshold, or the number of people who purchased the published work product with respect to a given threshold, and so forth. The thresholds can be set based on the specific implementation and considerations relating thereto. Further examples of successful application use outcomes are provided herein. Of course, other successful application use outcomes can also be used in accordance with the teachings of the present principles, while maintaining the spirit of the present principles.

The selective action performance determination device 450 determines whether to selectively perform an action responsive to any (one or more) of the following: the work product characteristics signals; and the successful application use outcomes.

In an embodiment, the selective action performance determination device 450 performs actions according to the application that is being used. The actions are performed to enhance the usage and performance of the applications, to reward a user based on the computed measures, push a particular product (e.g., a complimentary application), and so forth. Different actions can be performed depending upon the particular measure involved (e.g., complexity, quality, and/or expertise). Examples of such actions include and/or otherwise involve one or more of the following: a security compliance checker 451; a text analyzer 452; a machine learning important determination device 453; and a machine learning recommendation device 454.

The security compliance checker 451 includes a set of security compliance rules against which application license attributes of the at least one application are checked.

The text analyzer 452 automatically identifies work product from personal documents using a text analysis technique.

The machine learning determination device 453 determines an importance of the work product to improve a recommendation quality, using a machine learning technique.

The machine learning recommendation device 454 recommends an alternative application or a rental mechanism when the at least one application is hosted in a cloud, using a machine learning technique.

The determined action performer 460 performs (or causes to be performed) any action determined by the selective action performance determination device 450.

The social network analyzer 470 accesses one or more social networks. Results of the analysis can be used to, e.g., determine a degree of success of an application use outcome, determine an action to perform from among multiple available actions, make a suggestion (e.g., of an alternate application, a complimentary application, etc.), create a report, change application characteristics, offer a valid application license, offer a rental mechanism, and so forth. The social network analyzer 470 includes a degree centrality device 471, a betweenness centrality device 472, a closeness centrality device 473, an Eigenvalue determination device 474, a hub determination device 475, and an authority determination device 476. The degree centrality device 471 determines a degree centrality as described in further detail herein. The betweenness centrality device 472 determines a betweenness centrality as described in further detail herein. The closeness centrality device 473 determines a closeness centrality as described in further detail herein. The Eigenvalue determination device 474 determines an Eigenvalue as described in further detail herein. The hub determination device 475 determines a hub as described in further detail herein. The authority determination device 476 determines an authority as described in further detail herein.

In the embodiment shown in FIG. 4, the elements thereof are interconnected by a bus 401. However, in other embodiments, other types of connections can also be used. Moreover, in an embodiment, at least one of the elements of system 400 is processor-based. Further, while one or more elements may be shown as separate elements, in other embodiments, these elements can be combined as one element. The converse is also applicable, where while one or more elements may be part of another element, in other embodiments, the one or more elements may be implemented as standalone elements. Moreover, it is to be appreciated that various elements may be omitted altogether, depending upon the specific implementation including, for example, whether an outcome proxy server is used in conjunction with the outcome server 400. These and other variations of the elements of outcome server 400 are readily determined by one of ordinary skill in the art, given the teachings of the present principles provided herein, while maintaining the spirit of the present principles.

FIG. 5 shows an exemplary outcome proxy server 500 for outcomes-based application monitoring, in accordance with an embodiment of the present principles.

The outcome server 500 includes a receiver 510, a transmitter 520, an application characteristics monitor 530, an application use outcome success monitor 540, a selective action performance determination device 550; a determined action performer 560; a social network analyzer 570; and a proxy manager 580.

In an embodiment, the receiver 510 receives work product characteristics signals from, for example, applications in a device. The receiver 510 receives measures of the success of an application use outcome.

In an embodiment, the receiver 510 receives any of the following: an instruction to perform a particular action or set of actions relating, either directly or indirectly, to the application; a suggestion (e.g., of an alternate application, a complimentary application, an optimized application, and so forth) a report (e.g., regarding application usage, available application licenses, and so forth), an offer (e.g., of a valid application license, a rental mechanism, and so forth). The preceding can be received, e.g., from an outcome server (e.g., such as any of outcome servers 220 and 320).

In an embodiment, the transmitter 520 transmits any of the following: an instruction to perform a particular action or set of actions; a suggestion (e.g., of an alternate application, a complimentary application, an optimized application, and so forth) a report (e.g., regarding application usage, available application licenses, and so forth), an offer (e.g., of a valid application license, a rental mechanism, and so forth). The preceding can be transmitted, e.g., to a device (e.g., such as any of devices 210 and 310).

In an embodiment, the transmitter 520 transmits work product characteristics signals, e.g., to an outcome server (e.g., such as any of outcome servers 220 and 320). In an embodiment, the transmitter 520 transmits measures of the success of an application use outcome, e.g., to an outcome server (e.g., such as any of outcome servers 220 and 320).

The work product characteristics monitor 530 monitors characteristics of work products created using one or more applications.

The application outcome success monitor 540 monitors successful application use outcomes.

The selective action performance determination device 550 determines whether to selectively perform an action responsive to any (one or more) of the following: the work product characteristics signals; the application use outcomes; and the successful application use outcomes.

In an embodiment, the selective action performance determination device 850 includes a security compliance checker 551, a text analyzer 552, a machine learning important determination device 553, and a machine learning recommendation device 554.

The security compliance checker 551 includes a set of security compliance rules against which application license attributes of the at least one application are checked.

The text analyzer 552 automatically identifies work product from personal documents using a text analysis technique.

The machine learning determination device 553 determines an importance of the work product to improve a recommendation quality, using a machine learning technique.

The machine learning recommendation device 554 recommends an alternative application or a rental mechanism when the at least one application is hosted in a cloud, using a machine learning technique.

The determined action performer 560 performs (or causes to be performed) any action determined by the selective action performance determination device 550.

The social network analyzer 570 accesses one or more social networks. Results of the analysis can be used to, e.g., determine a degree of success of an application use outcome, determine an action to perform from among multiple available actions, make a suggestion (e.g., of an alternate application, a complimentary application, etc.), create a report, change application characteristics, offer a valid application license, offer a rental mechanism, and so forth. The social network analyzer 570 includes a degree centrality device 571, a betweenness centrality device 572, a closeness centrality device 573, an Eigenvalue determination device 574, a hub determination device 575, and an authority determination device 576. The degree centrality device 571 determines a degree centrality as described in further detail herein. The betweenness centrality device 572 determines a betweenness centrality as described in further detail herein. The closeness centrality device 573 determines a closeness centrality as described in further detail herein. The Eigenvalue determination device 574 determines an Eigenvalue as described in further detail herein. The hub determination device 575 determines a hub as described in further detail herein. The authority determination device 576 determines an authority as described in further detail herein.

The proxy manager 580 performs proxy operations to enable the outcome proxy server 580 to act as a proxy with respect to an outcome server that is disposed external to a device from which work product characteristics signals are received.

In the embodiment shown in FIG. 5, the elements thereof are interconnected by a bus 501. However, in other embodiments, other types of connections can also be used. Moreover, in an embodiment, at least one of the elements of system 500 is processor-based. Further, while one or more elements may be shown as separate elements, in other embodiments, these elements can be combined as one element. The converse is also applicable, where while one or more elements may be part of another element, in other embodiments, the one or more elements may be implemented as standalone elements. These and other variations of the elements of outcome proxy server 500 are readily determined by one of ordinary skill in the art, given the teachings of the present principles provided herein, while maintaining the spirit of the present principles.

FIG. 6 shows an exemplary method 600 for outcomes-based application monitoring, in accordance with an embodiment of the present principles. It is to be appreciated that while method 600 is described with respect to “at least one application”, in an embodiment the “at least one application” can be a cluster of applications.

At step 610, receive at least one work product characteristics signal from at least one application included in a device. The at least one work product characteristics signal includes information indicative of at least one characteristic of a work product creating using at least one application on the device.

At step 620, compute measures of at least one of a complexity, a quality, and an expertise level for the work product responsive to the work product characteristics signal.

In an embodiment, step 620 can include registering the work product with the server to trigger monitoring of the work product by the server. In an embodiment, the work product is registered using a unique identifier. In an embodiment, the expertise level is computed responsive to an amount of money made from disseminating the work product or from a non-pecuniary basis relating to disseminating the work product. Examples of non-pecuniary basis include, but are not limited to, peer recognition, an award, a number of views, a number of likes, and so forth. In an embodiment, the expertise level is computed based on a success of the work product, and wherein the action comprises deferring a payment of an outstanding amount due by a user of the device until the success is above a threshold success level.

There are many ways to compute complexity, quality, and expertise level for a work product, all of which can be exploited in accordance with the teachings of the present principles. For example, regarding expertise level and, in particular, an evolution in expertise level, we can monitor the number and nature of transfers of content between tools, along with sentence structure and complexity, and so forth. In an embodiment, text-based measures can be used. Metrics may also be applied in the musical arts and visual arts. For example, many schemes exist to measure the visual complexity of painting images. It is to be appreciated that the preceding metrics are merely illustrative and thus, other metrics can also be used in accordance with the teachings of the present principles, while maintaining the spirit of the present principles.

At step 630, track one or more of the following: a success of the particular outcome; a success of a similar outcome; other applications being at least one of executed at a same time and used to create a work product of the at least one application; a length of time the at least one application is used, a frequency of use of the at least one application, user input patterns used for the at least one application, and content sharing between applications within a given time period.

At step 640, determine whether to selectively perform an action using at least one hardware device responsive to the measures and/or the at least one application use outcome signal and/or one or more tracked items (e.g., one or more items tracked in step 920).

At step 650, perform the determined action, if applicable.

In an embodiment, the receiver of the work product characteristics signals may perform any of the following: suggest alternative or complementary applications based on usage of applications or application features of users in a social network; detect application security compliance; create a report regarding product use and/or licenses that are available for the product, change application characteristics (including, but not limited to, e.g., showing a red mark in the frame of an unlicensed application); offer a valid (potentially optimized) license; recommend downgrading/upgrading a license based on usage pattern to save the user come cost (e.g., downgrade the license if some of the features are not used but were nonetheless purchased); offer a rental mechanism (e.g., on a cloud) for the application or alternative application, or suggest an (optimal) application (including, but not limited to, e.g., an application that is easier to use and/or is more secure and/or has more accessibility features and/or so forth).

In an embodiment, the present principles can use rule-based, machine learning and text analysis techniques to detect outcomes and generate recommendations and actions based on the detected outcomes. In an embodiment, the present principles can include and/or otherwise involve any of the following: a set of security compliance rules against which the application license attributes can be checked; a text analysis technique to automatically identify work product from personal documents; a machine learning technique to determine the importance of the work product to improve the recommendation quality (e.g., the more time users work dedicatedly in a document within a certain period may reflect an increased importance of the work product); a machine learning technique to recommend alternative applications; and a rental mechanism if hosting the application in the cloud.

In an embodiment, the suggesting of alternate or complementary applications based on the usage of applications by users in a social network can involve monitoring the use of applications by other users in a social network of a user. This may be done in an opt-in way so that privacy is not sacrificed. Users may wish to opt-in, since they may be interested in learning about applications that colleagues are using. For example, if a user is a commercial artist, she may wish to learn what other commercial artists are using to produce works.

When performing the social network analysis, consideration may be given to various network metrics, including the following:

i. How does information flow within a network, and
for a given entity within a network,
ii. How highly connected is the given entity within the network?
iii. What is its overall importance in the network?
iv. How central is it within the network?

The following characteristics may be considered: degree centrality; betweenness centrality; closeness centrality; Eigenvalue; hub; and authority. For example, if a user is considered very “important” in a social network, information regarding that user's usage may be given stronger weight. A user may be interested in knowing not only when the number of colleagues (e.g. in a social network or an organization at work) exceed a threshold for usage of a newer version of an application), but also when the number of “key” users exceed a threshold.

These characteristics are explained hereinafter as follows.

### (a) Degree Centrality.

The number of direct relationships of an entity indicates its degree centrality. Thus, degree centrality can refer to the number of links tied to a node. In the case of a directed network (where ties have direction), there can be two separate measures of degree centrality, namely indegree and outdegree. Indegree is a count of the number of ties directed to the node and outdegree is the number of ties that the node directs to others. An entity with high degree centrality in a network:
i. is generally an active player therein;
ii. is often a connector or hub therein;
iii. is not necessarily the most connected entity therein (an entity may have a large number of relationships, most of which point to low-level entities);
iv. may be in an advantaged position therein;
v. may have alternative ways to satisfy organizational needs and, as a result, may be less dependent on other individuals; and
vi. can often be considered third parties or deal makers.

### (b) Betweenness Centrality.

Betweenness centrality identifies an entity's position within a network in terms of being able to connect to other pairs or groups in a network. Thus, betweenness centrality can refer to the centrality measure of a vertex within a graph. Betweenness centrality quantifies the number of times a node acts as a bridge along the shortest path between two other nodes. An entity with a high betweenness centrality generally:
i. holds an advantageous position in the network;
ii. represents a single point of failure; and
iii. has more influence over network happenings.

### (c) Closeness Centrality.

Closeness centrality measures the speed with which an entity can access more entities in a network. An entity with a high closeness centrality generally:
i. has quick access to other network entities;
ii. has a short path and/or is close to other entities; and
iii. has high visibility to network happenings.

If the network includes any entities that are not linked to any other entities, the Closeness Centrality value for all entities in the network is 0.

### (d) Eigenvalue.

Eigenvalue measures, within a network, how close an entity is to other highly close entities. In other words, Eigenvalue identifies the most central entities in terms of the global or overall network makeup. A high Eigenvalue indicates that an actor is central to the main pattern of distances among all entities. Thus, Eigenvector centrality can refer to an amount of influence of a node in a network.

### (e) Hub.

Entities that point to a relatively large number of authorities are referred to as hubs. Hubs are mutually reinforcing analogues to authorities. Authorities point to high hubs, and hubs point to high authorities.

### (f) Authority.

Authorities are entities that many other entities point to. An entity may be considered an authority if the entity has a high number of relationships pointing value, and generally:
i. is a knowledge authority or organizational authority within a domain.
ii. acts as definitive source of information.

Similarly, outcomes of such usage can be tracked. One way to do this is automatically, using some of the aforementioned schemes. For example, tracking the publishing of a work product may be determined when a user uploads an e-book to Amazon.com® for publication, and the associated tools used to create this may be inferred. Also, a user may actually wish to manually indicate when an outcome has taken place. Additionally, the present principles can track other applications being run at the same time and/or used in the creation of a work product. Moreover, the present principles can track the length of time using the application, input patterns used with the application (keyboard patterns, rate of input, voice, etc.), and so forth.

Clusters: The application of the present principles to clusters of applications is intriguing, because many outcomes may depend on a cluster of applications. For example, if a user publishes a book, she may use a paint program, a word processor, and other tools. Thus, the receiver of work product characteristics signals can perform any of the following on clusters of applications: suggest alternative or complementary application clusters based on usage of applications of users in a social network; create a report regarding product use and/or licenses that are available for product clusters; changes application cluster characteristics (including, but not limited to, e.g., showing a red mark in the frame of one or more unlicensed applications, and so forth); offer a valid (potentially optimized) license for the cluster of applications, offer a rental mechanism (e.g., on a cloud) for the application cluster or alternative application cluster; suggest an (optimal) application cluster (including, but not limited to, e.g., an application that is easier to use, is more secure, has more accessibility features, and so forth).

Additional options may be considered. In an embodiment, based on outcomes, it may be possible to use the system/method of the present principles to determine whether a user of a computer system on which software is installed is using the software sufficiently to justify its cost, and the thresholds for determining whether a user is sufficiently using software may change over time as the price of the software and alternative software changes and the availability of alternatives changes. Similarly, in an embodiment, non-invasive monitoring of software applications can be performed, wherein the present principles can be adapted for: (a) during execution of at least one software application within the runtime environment, identifying a work product characteristics signal from a function call that is executed by the at least one software application; and (b) generating monitoring data relating to the identified work product characteristics signal from a function call.

A description will now be given regarding cognitive aspects of the present principles.

Outcomes that can be exploited in accordance with the present principles include, but are not limited to, any of the following cognitive-related outcomes: a satisfaction with (or quality of) the outcome (e.g., as determined by voting at YouTube®; number of re-tweets of an art-piece via Twitter®; assessment by a social network; a biometric that indicates satisfaction, and so forth).

One way to explain the rational for this use of quality and popularity of a work-product is as follows. A user may not need to worry about application license details while he or she is learning, and while the output (e.g., book, visual artwork, music, etc.) is simple or of low quality. However, the system disclosed herein may be triggered if the outcome finally rises to a certain level of quality, complexity, or popularity. At this point, an appropriate application license may be warranted and offered.

Note that the degree of satisfaction or degree of perceived quality can have a differential effect (e.g. a gradual effect and/or variable effect) on the various actions such as the suggestion of alternative or complementary applications offering of a valid (potentially optimized) license, and so forth. For example, as the complexity, quality, and user proficiency associated with a work-product or outcome slowly increases, various different applications, application features, or application licenses may be offered as different levels of complexity or quality are reached. Similarly, as the popularity or sales of a work-product or outcome slowly increases, various different applications, application features, or application licenses may be offered as different levels of popularity or sales are reached. Of course, a work product may have different degrees of (or numbers of) downloads, references, votes, payments, comments, re-tweets, and so forth, which may indicate a certain degree of satisfaction, delight, anger, and so forth (if automated sentiment determination is performed).

As a work product improves (e.g., as an author's book is being published through many iterations), the monitoring of this change in quality can take place until the “outcome” quality exceeds a threshold, at which point one or more actions can be taken. In this sense, a system and/or method in accordance with the present principles can be adaptive and cognitive. The system and/or method can learn as information changes and as goals and requirements evolve. Similarly, the system and/or method can “understand”, identify, and extract contextual elements such as meaning, syntax, time, location, appropriate domain, regulations, user's profile, process, task and goal. The system may draw on multiple sources of information, including both structured and unstructured digital information, as well as sensory inputs (e.g., visual, gestural, auditory, or sensor-provided).

It is to be appreciated that license compliance can depend on the outcome of an application instead of use of the application itself. The outcome refers to the “end-product” of the application.

The owner of the application or data can impose restrictions on how the application or data can be used. For example, National Institutes of Health (NIH) makes most of their data set available to public. However, in order to download the data, the customers often need to sign the agreement that it will not be used for commercialization.

A description will now be given regarding tracking outcomes, in accordance with an embodiment of the present principles.

When a work product is created, this “outcome” can be tracked in several ways. Of course, every application used to operate on (e.g., edit) the product can leave a trace (e.g., metadata in a header of a file) that provides an indication of the tool(s) used to create the product. When this product is published (for example, if an animation is published to YouTube®, or a printer is used to print the product), this information can be read and acted upon as described herein. For example, YouTube® may actually agree upon a standard for metadata to which content providers, application developers, other affected and/or interested parties, data formats, and so forth conform. This information may be encrypted.

In an embodiment, the pull or push-based signaling can be used to collect information about what applications have been used. For example, in an embodiment, as an application is running, it may be send out signals that are collected, along with a unique identifier (ID) that corresponds to the work product. Then, the outcome server (e.g., analyzer of work product characteristics signals) can facilitate many of the outcomes discussed herein, such as suggesting alternative or complementary apps, offering valid (potentially optimized) licenses, changing the graphical user interface (GUI) of an application, and so forth. The Unique IDs can function as a kind of “bar code” that may be scanned or monitored by one or more agencies.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load balancing between clouds).

A cloud computing environment is service oriented with a focus on statelessness, low coupling, modularity, and semantic interoperability. At the heart of cloud computing is an infrastructure comprising a network of interconnected nodes.

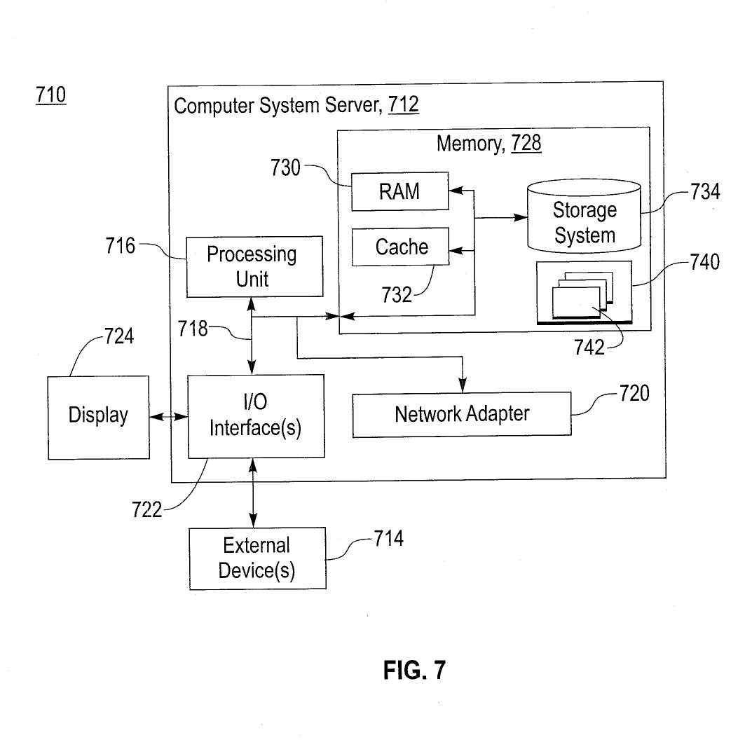

Referring now to FIG. 7, a schematic of an example of a cloud computing node 710 is shown. Cloud computing node 710 is only one example of a suitable cloud computing node and is not intended to suggest any limitation as to the scope of use or functionality of embodiments of the invention described herein. Regardless, cloud computing node 710 is capable of being implemented and/or performing any of the functionality set forth hereinabove.

In cloud computing node 710 there is a computer system/server 712, which is operational with numerous other general purpose or special purpose computing system environments or configurations. Examples of well-known computing systems, environments, and/or configurations that may be suitable for use with computer system/server 712 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 712 may be described in the general context of computer system executable instructions, such as program modules, being executed by a computer system. Generally, program modules may include routines, programs, objects, components, logic, data structures, and so on that perform particular tasks or implement particular abstract data types. Computer system/server 712 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 7, computer system/server 712 in cloud computing node 710 is shown in the form of a general-purpose computing device. The components of computer system/server 712 may include, but are not limited to, one or more processors or processing units 716, a system memory 728, and a bus 718 that couples various system components including system memory 728 to processor 716.

Bus 718 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 712 typically includes a variety of computer system readable media. Such media may be any available media that is accessible by computer system/server 712, and it includes both volatile and non-volatile media, removable and non-removable media.

System memory 728 can include computer system readable media in the form of volatile memory, such as random access memory (RAM) 730 and/or cache memory 732. Computer system/server 712 may further include other removable/non-removable, volatile/non-volatile computer system storage media. By way of example only, storage system 734 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 718 by one or more data media interfaces. As will be further depicted and described below, memory 728 may include at least one program product having a set (e.g., at least one) of program modules that are configured to carry out the functions of embodiments of the invention.

Program/utility 740, having a set (at least one) of program modules 742, may be stored in memory 728 by way of example, and not limitation, as well as an operating system, one or more application programs, other program modules, and program data. Each of the operating system, one or more application programs, other program modules, and program data or some combination thereof, may include an implementation of a networking environment. Program modules 742 generally carry out the functions and/or methodologies of embodiments of the invention as described herein.

Computer system/server 712 may also communicate with one or more external devices 714 such as a keyboard, a pointing device, a display 724, etc.; one or more devices that enable a user to interact with computer system/server 712; and/or any devices (e.g., network card, modem, etc.) that enable computer system/server 712 to communicate with one or more other computing devices. Such communication can occur via Input/Output (I/O) interfaces 722. Still yet, computer system/server 712 can communicate with one or more networks such as a local area network (LAN), a general wide area network (WAN), and/or a public network (e.g., the Internet) via network adapter 720. As depicted, network adapter 720 communicates with the other components of computer system/server 712 via bus 718. It should be understood that although not shown, other hardware and/or software components could be used in conjunction with computer system/server 712. Examples, include, but are not limited to: microcode, device drivers, redundant processing units, external disk drive arrays, RAID systems, tape drives, and data archival storage systems, etc.

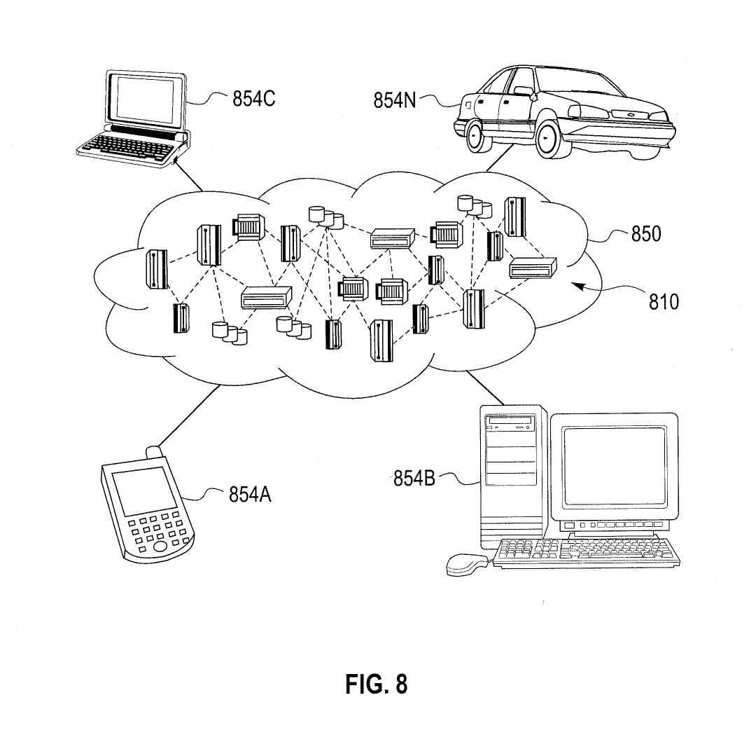

Referring now to FIG. 8, illustrative cloud computing environment 850 is depicted. As shown, cloud computing environment 850 comprises one or more cloud computing nodes 810 with which local computing devices used by cloud consumers, such as, for example, personal digital assistant (PDA) or cellular telephone 854A, desktop computer 854B, laptop computer 854C, and/or automobile computer system 854N may communicate. Nodes 810 may communicate with one another. They may be grouped (not shown) physically or virtually, in one or more networks, such as Private, Community, Public, or Hybrid clouds as described hereinabove, or a combination thereof. This allows cloud computing environment 850 to offer infrastructure, platforms and/or software as services for which a cloud consumer does not need to maintain resources on a local computing device. It is understood that the types of computing devices 854A-N shown in FIG. 8 are intended to be illustrative only and that computing nodes 810 and cloud computing environment 850 can communicate with any type of computerized device over any type of network and/or network addressable connection (e.g., using a web browser).

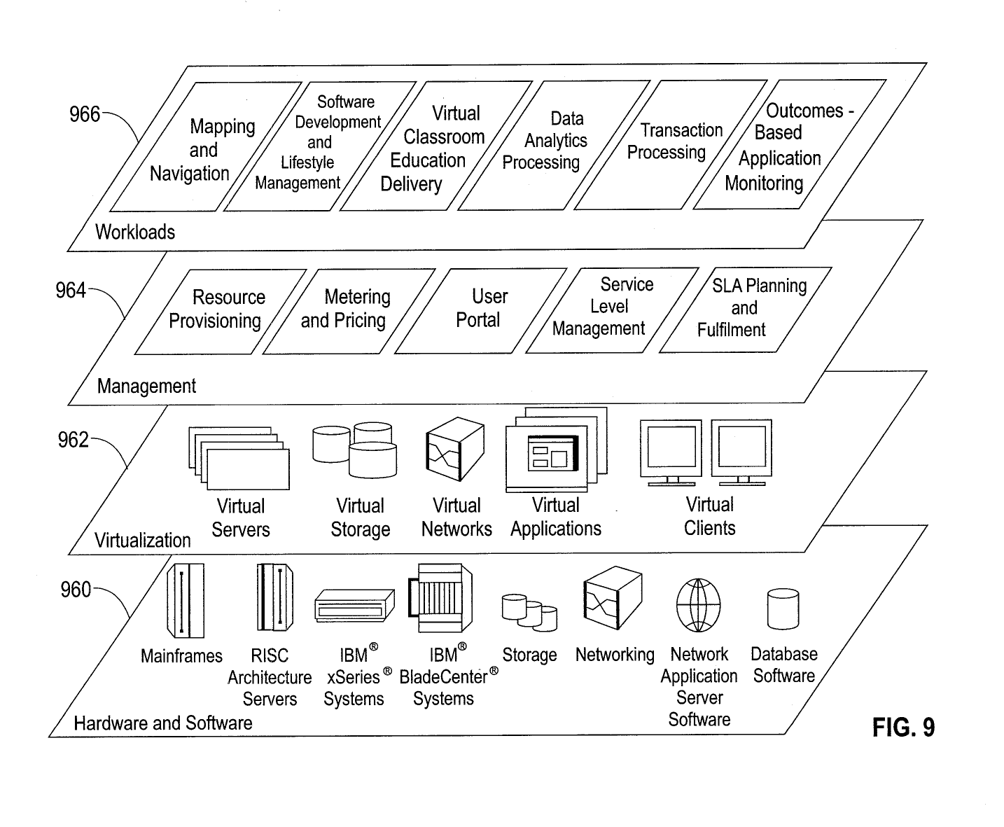

Referring now to FIG. 9, a set of functional abstraction layers provided by cloud computing environment 850 (FIG. 8) is shown. It should be understood in advance that the components, layers, and functions shown in FIG. 9 are intended to be illustrative only and embodiments of the invention are not limited thereto. As depicted, the following layers and corresponding functions are provided:

Hardware and software layer 960 includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide).

Virtualization layer 962 provides an abstraction layer from which the following examples of virtual entities may be provided: virtual servers; virtual storage; virtual networks, including virtual private networks; virtual applications and operating systems; and virtual clients.

In one example, management layer 964 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA.

Workloads layer 966 provides examples of functionality for which the cloud computing environment may be utilized. Examples of workloads and functions which may be provided from this layer include: mapping and navigation; software development and lifecycle management; virtual classroom education delivery; data analytics processing; transaction processing; and outcomes-based application monitoring.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Reference in the specification to “one embodiment” or “an embodiment” of the present principles, as well as other variations thereof, means that a particular feature, structure, characteristic, and so forth described in connection with the embodiment is included in at least one embodiment of the present principles. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

Having described preferred embodiments of a system and method (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

What is claimed is:

1. A method, comprising:
receiving, by a server, characteristics of a work product produced by using at least one application in a device;
computing, by the server, measures of at least one of a complexity, a quality, and an expertise level for the work product responsive to the characteristics; and
determining, by the server, whether to cause at least one hardware device to selectively perform an action relating to using the application, responsive to the measures.

2. The method of claim 1, wherein the measures are determined using a social network.

3. The method of claim 2, wherein the measures are determining using at least one of a degree centrality, a betweenness centrality, a closeness centrality, an Eigenvalue, a hub, and an authority of nodes that are associated with the measures, from among a plurality of nodes in the social network.

4. The method of claim 1, further comprising calculating a success of the work product, and wherein said determining step determines whether to selectively perform the action further responsive the success of the work product.

5. The method of claim 1, further comprising calculating, using a social network, a success of a similar work product, and wherein said determining step determines whether to selectively perform the action further responsive the success of the similar work product.

6. The method of claim 1, wherein the measures are determined based on at least one of receiving money for the work product, receiving a non-pecuniary benefit for the work product, publishing the work product, emailing the work product, printing the work product, using a peripheral device to at least one of convey or generate the work product, sharing the work product with one or more other users, and sharing the work product between different devices.

7. The method of claim 1, wherein the action comprises at least one of:
offering at least one of an alternate application and a complementary application based on application usage by users in a social network;
creating a report regarding at least one of the application usage and available application licenses;
changing application characteristics;
offering an application license optimized for a user of the device;
offering a rental mechanism for at least one of, the at least one application, an alternate application, and a complimentary application; and
offering at least one application optimized for the user of the device.

8. The method of claim 7, wherein the action is selected based upon at least one of a degree centrality, a betweenness centrality, a closeness centrality, an Eigenvalue, a hub, and an authority of nodes that are associated with the action, from among a plurality of nodes in the social network.

9. The method of claim 1, wherein said computing step comprises tracking, by the server, other applications being at least one of executed at a same time and used to create the work product.

10. The method of claim 1, wherein said computing step comprises tracking, by a server, a length of time the at least one application is used, a frequency of use of the at least one application, user input patterns used for the at least one application, and content sharing between the at least one application and at least one other application within a given time period.

11. The method of claim 1, wherein the server includes or uses, for determining whether to selectively perform the action, at least one of:
a set of security compliance rules against which application license attributes of the at least one application are checked;
a text analysis technique to automatically identify work product from personal documents;
a machine learning technique to determine an importance of the work product to improve a recommendation quality; and
a machine learning technique to recommend an alternative application or a rental mechanism when the at least one application is hosted in a cloud.

12. The method of claim 1, further comprising registering the work product with the server to trigger monitoring of the work product by the server, wherein the work product is monitored to compute the measures.

13. The method of claim 12, wherein the work product is registered using a unique identifier, and wherein the work product is monitored using the unique identifier.

14. The method of claim 1, wherein the action comprises offering an upgraded license corresponding to a higher expertise level when the expertise level is above a threshold expertise level.

15. The method of claim 14, wherein the expertise level is computed responsive to an amount of money made from disseminating the work product or from a non-pecuniary basis relating to disseminating the work product.

16. The method of claim 1, wherein the expertise level is computed based on a success of the work product, and wherein the action comprises deferring a payment of an outstanding amount due by a user of the device until the success is above a threshold success level.
